(19) United States
(12) Patent Application Publication
(10) Pub. No.: US 2006/0070066 A1
(43) Pub. Date: Mar. 30, 2006

(54) Enabling platform network stack control in a virtualization platform

(76) Inventor: Steven L. Grobman, El Dorado Hills, CA (US)

Correspondence Address: INTEL CORPORATION, P.O. BOX 5326, SANTA CLARA, CA, 95056-5326, US

(21) Appl. No.: 10/954,905

(22) Filed: Sep. 30, 2004

(51) Int. Cl. G06F 9/455

(52) U.S. Cl. 718/1

(57) ABSTRACT

In some embodiments, the invention involves protecting network communications in a virtualized platform. An embodiment of the present invention is a system and method relating to protecting network communication flow using packet encoding/certification and the network stack. One embodiment uses a specialized engine or driver in the network stack to encode packets before being sent to physical network controller. The network controller may use a specialized driver to decode the packets, or have a hardware implementation of a decoder. If the decoded packet is certified, the packet is transmitted. Otherwise, the packet is dropped. An embodiment of the present invention utilizes virtualization architecture to implement the network communication paths. Other embodiments are described and claimed.

### FIELD OF THE INVENTION

An embodiment of the present invention relates generally to computing systems and, more specifically, to protecting network communications in a virtualized platform.

### BACKGROUND INFORMATION

Various mechanisms exist for protecting spurious information from being transmitted over a network. Existing platforms may run an operating system (OS) on the equivalent of bare hardware. In other words, the OS communicates directly with the physical devices on the platform, often using device drivers or direct memory access (DMA). Coupled to the hardware may be a network interface card (NIC), graphics card and other hardware components. When security applications, such as, a firewall or intrusion detection are run on a platform, rogue applications within the operating system partition may disable, destroy, manipulate or corrupt the operating system services. A user may intentionally or unintentionally turn off security capabilities. It is desirable to protect the agents running on a system that may prevent security breaches or protect other system policies.

### BRIEF DESCRIPTION OF THE DRAWINGS

The features and advantages of the present invention will become apparent from the following detailed description of the present invention in which:

FIG. 1 is a block diagram illustrating a virtualization platform implemented in a hypervisor virtual machine manager (VMM) architecture, according to an embodiment of the invention;

FIG. 2 is a block diagram illustrating a host-based VMM architecture, according to an embodiment of the invention;

FIG. 3 is a block diagram illustrating prohibited and desired communications paths in an embodiment of a host-based VMM management partition;

FIG. 4 is a block diagram illustrating a network stack which may be used in an embodiment of the invention;

FIG. 5 is a block diagram illustrating communication between a virtual network stack and a physical network stack in a host-based embodiment of the invention;

FIG. 6 is a block diagram illustrating a management partition architecture with a hardware augmented network controller; and

FIG. 7 is a table illustrating various security levels of alternative embodiments of the present invention.

### DETAILED DESCRIPTION

An embodiment of the present invention is a system and method relating to protecting network communication flow using packet encoding/certification and the network stack. One embodiment uses a specialized engine or driver in the network stack to encode packets before being sent to a network interface card (NIC). The NIC may use a specialized driver to decode the packets, or have a hardware or firmware implementation of a decoder. If the decoded packet is certified/authenticated, the packet may be transmitted. Otherwise, the packet may be dropped. An embodiment of the present invention utilizes virtualization architecture to implement the network communication paths via virtual network interfaces.

In one embodiment, a management partition may be run on a virtualization platform. This architecture uses a virtual network stack, as above. Another embodiment enables a sending application to mark outgoing packets in such a way so that the NIC may authenticate the packet. The application may utilize an agent, service or be hard-coded to provide the appropriate encryption, encoding or digital signatures.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

For purposes of explanation, specific configurations and details are set forth in order to provide a thorough understanding of the present invention. However, it will be apparent to one or ordinary skill in the art that embodiments of the present invention may be practiced without the specific details presented herein. Furthermore, well-known features may be omitted or simplified in order not to obscure the present invention. Various examples may be given throughout this description. These are merely descriptions of specific embodiments of the invention. The scope of the invention is not limited to the examples given.

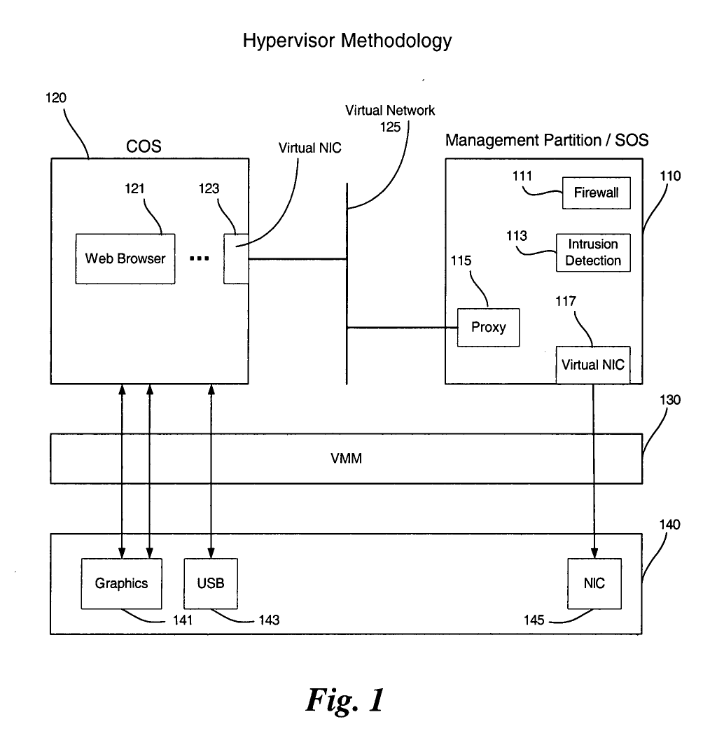

A variety of methods may be used to protect network communication in a platform or network. An embodiment of a platform using a proxy server to protect network communications is described in copending U.S. application Ser. No. 10/875,833 (Attorney Docket No. P18666), filed on Jun. 23, 2004, entitled, “Method, Apparatus And System For Virtualized Peer-To-Peer Proxy Services” to Steve Grobman, et al. and assigned to a common assignee. FIG. 1 illustrates an exemplary virtualized platform 100 running with a management partition 110. The management partition 110 may also be referred to as a service operating system (SOS). The part of the platform with which a user interacts is called a capability operating system (COS) 120. In one embodiment, the COS may run in a guest virtual machine (VM) in a hypervisor architecture. In a hypervisor architecture, a virtual machine monitor (VMM) 130 runs on a platform to control and monitor virtual machine activities. In a hypervisor architecture, there may not be an underlying host general purpose operating system. In another embodiment, the COS may run in a host operating system (OS) using a host-based virtual machine monitor (VMM). In a classic architecture, virtualization technology may be implemented on the x86 class of platforms available from Intel Corporation, for instance, using existing virtualization products. In an embodiment, virtualization technology is used to directly map much of the hardware 140 that physically exists on the platform directly into the COS 120, except for the physical NIC 145. The NIC 145 may be mapped into the management partition 110. In general, threats to the integrity of a platform or network come from, or go to, the network. Thus, it is important for the NIC 145 to be secure. Further, for other hardware, for instance, a graphics card 141, or USB port 143, it may be important to have a direct connection to the hardware from a partition, or guest virtual machine (VM), to maintain processing speed.

Services that should be protected from corruption by a rogue application or other damage may be moved into a management partition, for instance, a firewall 111, intrusion detection 113, or other services 115, 117. In one embodiment, a proxy server 115 is put into the management partition 110 to control transmitted content. By using a proxy server 115 in the management partition to trap all network communication from a web browser 121, for instance, communications are protected regardless of whether the platform is connected to a host network or merely connected directly to the Internet. Using a proxy server effectively sets up a virtual network 125 within the platform via a virtual NIC 123. The virtual NIC 123 appears to the COS 120 as if it were a physical NIC. The virtual NIC 123 may be communicatively coupled to a network stack (not shown) which is connected to the management partition 110.

In this way, all network traffic may be routed through, or monitored by, the management partition 110. In the case of a proxy server 115, if a web browser 121 in the COS 120 attempts to access a restricted site on the Internet, the management partition 110 may restrict the web browser 121 from accessing the site because the web browser communicates through the proxy server and is not directly connected to the NIC 145. Communications using port 80 (the conventional port for web browsers), for instance, may be forced to go through the proxy server 115. The proxy server 115 in the management partition 110 may then block certain sites or content. A system administrator for an enterprise platform, or parents managing a home computer, may control the proxy server 115. Firewalls 111 may be protected from viruses running in the COS 120, as well. Capabilities such as firewalls running in a partition other then the user's partition should not be affected by malware (malicious software) and/or user intervention because of the protections enforced by the VMM architecture. Users running applications in the COS 120 may not disable the firewall 111 or other software running in the management partition 110. In this architecture, a VMM may provide memory protection and independent execution environments such that partitions cannot access memory controlled by another partition.

One feature virtualization technology may enable is the ability to directly map hardware through to a VM partition. Hardware components 140 on the platform may be directly mapped to a dedicated VM partition 120 and 110. Processor technology and/or chipset technology may specifically allow this mapping. A chipset modification may be required to transparently offset memory addressing such that direct memory access (DMA) works in arbitrary partitions. NICs and other devices transfer data using DMA so that they may transfer data from the device to/from memory without going through the processor. Typically a virtual machine manager (VMM) creates a virtual network that would allow the COS 120 to communicate to the SOS 110 which would then route or use a network address translator (NAT) or bridge the network traffic to the physical NIC 145. As described, this management partition is implemented in the context of a hypervisor architecture.

Another standard VMM architecture is called a host-based VMM architecture. In this architecture, all hardware is typically mapped to a host operating system (OS). Instead of the management partition and capability operating system residing in separate partitions, the management partition resides inside of the host partition, under a host operating system. The host operating system may run at a higher privileged mode than guest virtual machine (VM) operating systems.

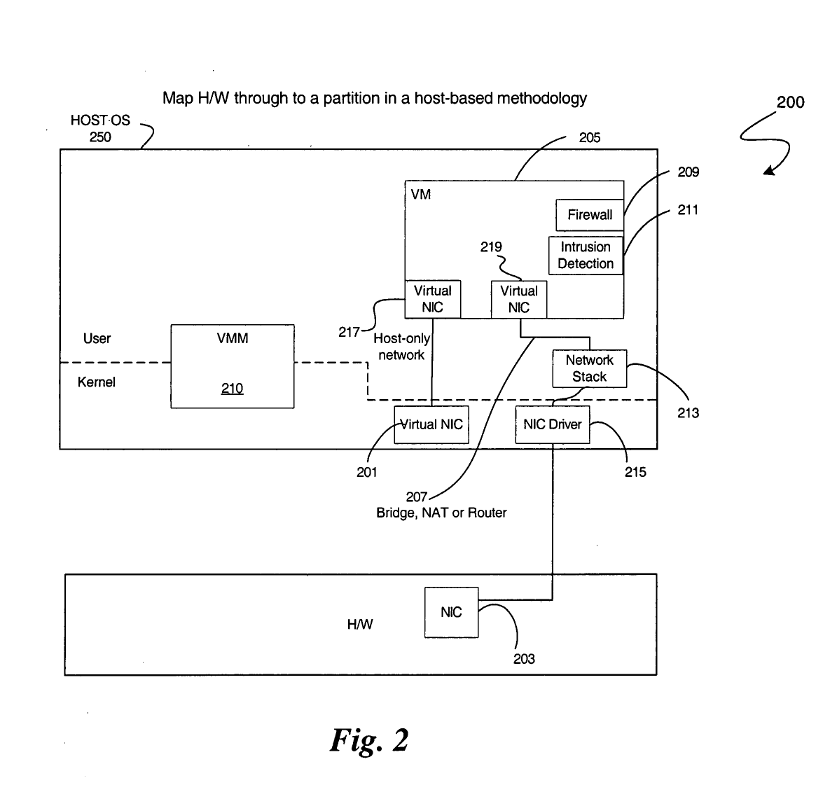

FIG. 2 shows an exemplary host-based VMM architecture 200. A version of host-based VMM architecture may be used in existing systems using VMWare and Virtual PC software packages, for instance, available from Microsoft Corporation and usable under Windows™ and Linux operating systems. It will be appreciated that these operating systems and VMM architectures are exemplary only, and that other operating systems and/or VMM architectures may be used. In an embodiment, a VMM 210 runs inside of the host OS partition 250. Portions of the VMM 210 may run at the Kernel level and create a virtual NIC 201 and 219. The virtual NIC 219 allows a VM to communicate over a network and is typically bridged or routed (207) through the VMM 210 to the physical NIC 203 via a network stack 213 and NIC driver 215. Additionally, one may create a virtual NIC 217 within a VM that bridges just to the host itself. In other words, there may be no automatic network connectivity between the partition and the outside world. This “host only” network provides a communication channel between the partitions (or the host and guest). To illustrate the concept, a platform may exist with no “real” NIC cards or networking capabilities, but may have virtual NIC cards that would enable inter-partition communication.

A virtual NIC 219 may be communicatively coupled to a physical NIC 203, via the NIC driver 215, where the virtual NIC 219 is communicatively coupled to a virtual machine (VM) 205 via a network stack 213. The VM 205 may communicate to the virtual NIC 219 via a network address translator (NAT) or by Ethernet bridging (207). The VM may be a management partition having a firewall process 209 and/or an intrusion detection process 211. The VM 205 does not have direct access to the physical NIC 203, however, and must communicate to the network through the virtual NIC 219.

An embodiment of the present system and method may be implemented in a host-based VMM architecture. The host may route the network traffic through the virtual NIC 219 into the VMM 210 through the network stack 213 and back thru the bridged or NAT'ed or routed network to the physical NIC 203 then out onto the network.

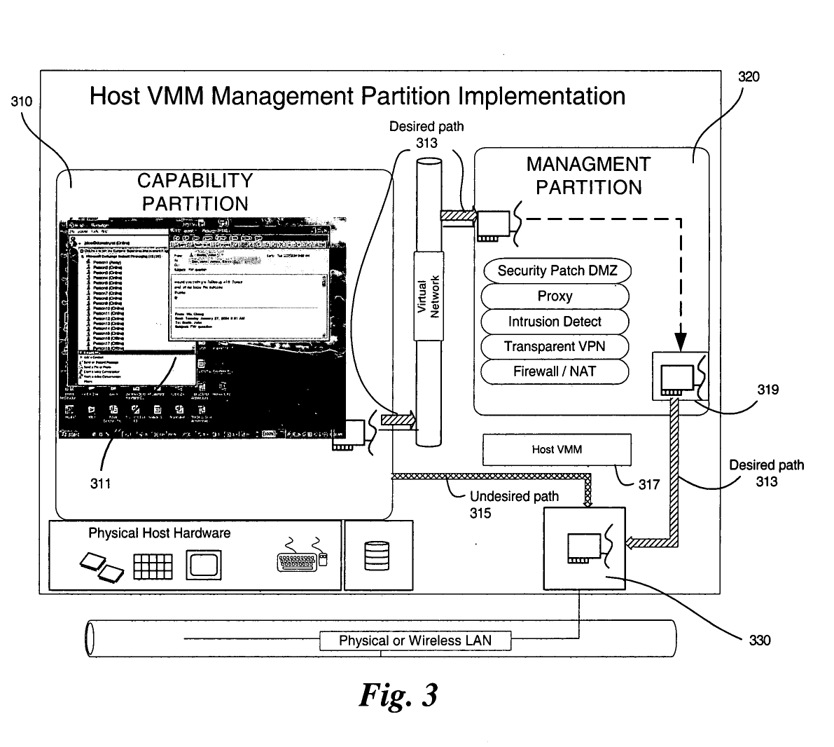

FIG. 3 illustrates a host-based VMM architecture showing a preferred communication path 313. It is desirable for network communication from, for instance a web browser 311 running in a COS 310, to be trapped by the management partition 320 and then be routed to the physical NIC 330. It may be prohibited for the web browser 311 to transmit packets directly to the physical NIC 330 along an undesired path 315. Embodiments of the system and method described herein enable the undesired path 315 to be prohibited, and may forced the use of the virtual networking path enabled by the VMM 317 and virtual network interface card (VNIC) 319.

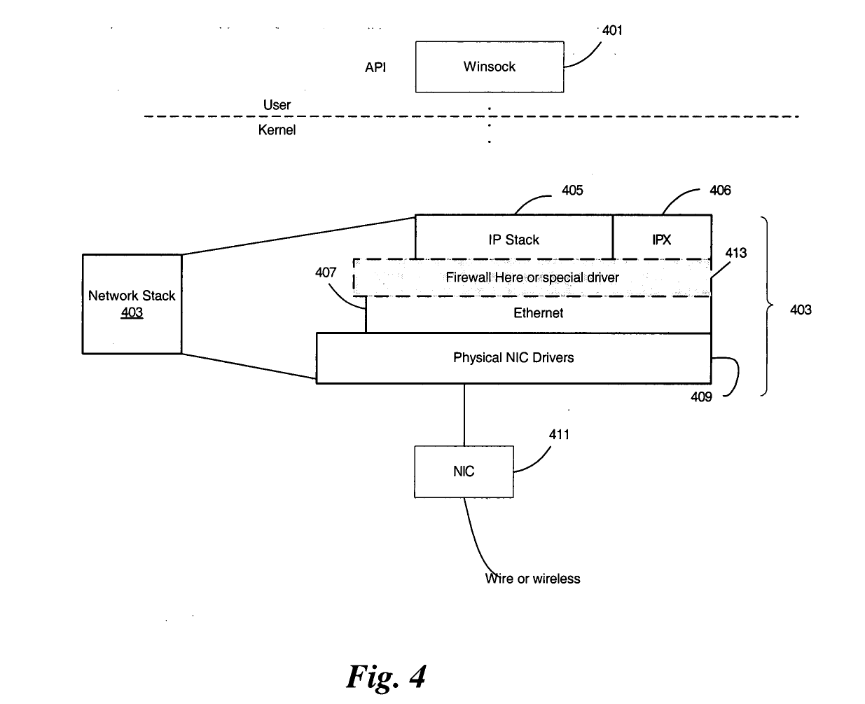

FIG. 4 illustrates how an exemplary network stack communicates with a NIC in an operating system, such as, for example, a Microsoft® Windows™ environment. An application program interface (API), such as Winsock 401, operates at the user level and communicates with the user's processes. When a network communication is requested by a user, the API 401 communicates with the network stack 403. A typical network stack may have multiple protocol levels such as an Internet Protocol stack 405, an IPX stack 406 (typically used with Novell® networks), an Ethernet protocol 407 and physical NIC drivers 409. The NIC drivers 409 communicate with the physical NIC 411 to access the actual network. Firewall capabilities 413 may be inserted into the network stack before the Ethernet layer 407. Other specialized drivers that act on packets sent or received to/from the network stack 403 may be executed at 413. A VM may interact with a virtual network stack using the same API calls that a web browser, for instance, might use. Thus, the VM need not worry about the physical make up of the machine.

A goal of a management partition in a virtualized platform may be to protect the services running on a VM and force all network traffic to navigate through the services, or at least enforce this communication path for specific processes. There may be a problem with building a management partition in a host-based VMM architecture, because the OS is linked to the physical NIC. There may be nothing to prevent an application from circumnavigating the defined communication path. Hardware virtualization capabilities such as may be delivered with some virtualization platforms enable the permitted communication path to be defined and prohibit short-circuiting of the path using DMA or other techniques to access the real network stack. The VMM must typically access the real network stack, so the real network stack may not be disabled. Software that is running within the VMM puts packets out onto the “wire” or network, via the network stack.

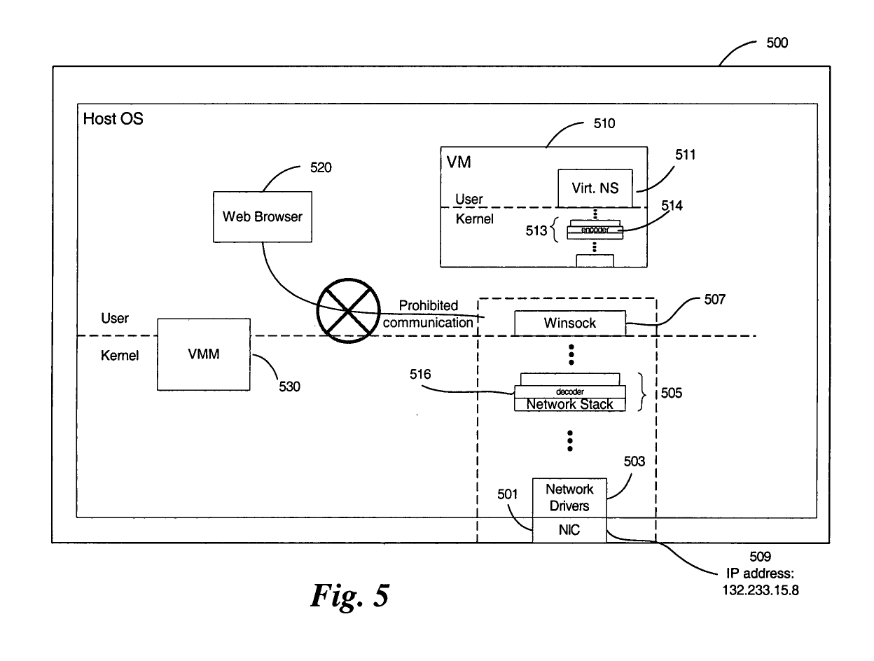

The system and method as described herein prevents applications from accessing the network stack without going through a virtual NIC controlled by the VMM or management partition. FIG. 5 shows an exemplary host-based VMM environment 500 in which an embodiment of the present invention may reside. A physical NIC 501 is communicatively coupled with network drivers 503. The network drivers 503 communicate with the physical network stack 505. A series of API modules 507, such as Winsock, communicate with the network stack 505. The user mode API modules 507 are accessed by the user applications in a host-based VMM environment. It is desired that only VM 510 may communicate with the network stack 505. A web browser 520 is prohibited from communicating directly to the network stack 505 using the user APIs 507 or other methods. The network stack 505 for the NIC 501 may have an Internet protocol (IP) address 509 of 132.233.15.8. The disclosed system and method prevents the web browser 520 from directly accessing the IP address 509.

In an embodiment using a software implementation, the VM 510 has a virtual network stack 511. The virtual network stack includes a specialized driver 514 at the kernel level of the guest VM. In some embodiments, a VMM 530 may execute kernel guest code in processor ring-3, or user mode, (for IA-32 architecture). In some embodiments, a VMM 530 may execute kernel guest code in native ring-0 mode. For Intel architecture, and the like, ring-0 is a most privileged processor mode, and ring-3 is a lesser privileged mode. Future platforms may have a privilege level higher than ring-0. It will be apparent to one of ordinary skill in the art that various implementations of privilege levels may be used in practicing embodiments of the disclosed invention. In an embodiment, there is guest code, which may be in the form of an agent or process coupled to the network stack, which may encrypt or digitally sign or encode the packet to be sent out over the network. The NIC 501 may be configured to send only properly decoded and validated packets. The physical network stack 505 may have a specialized driver 516 to decode the packets received from the virtual network stack 513. This method may be a viable option for systems where specialized hardware is not possible and where applications running on the platform are trusted not to attempt to bypass the specialized drivers.

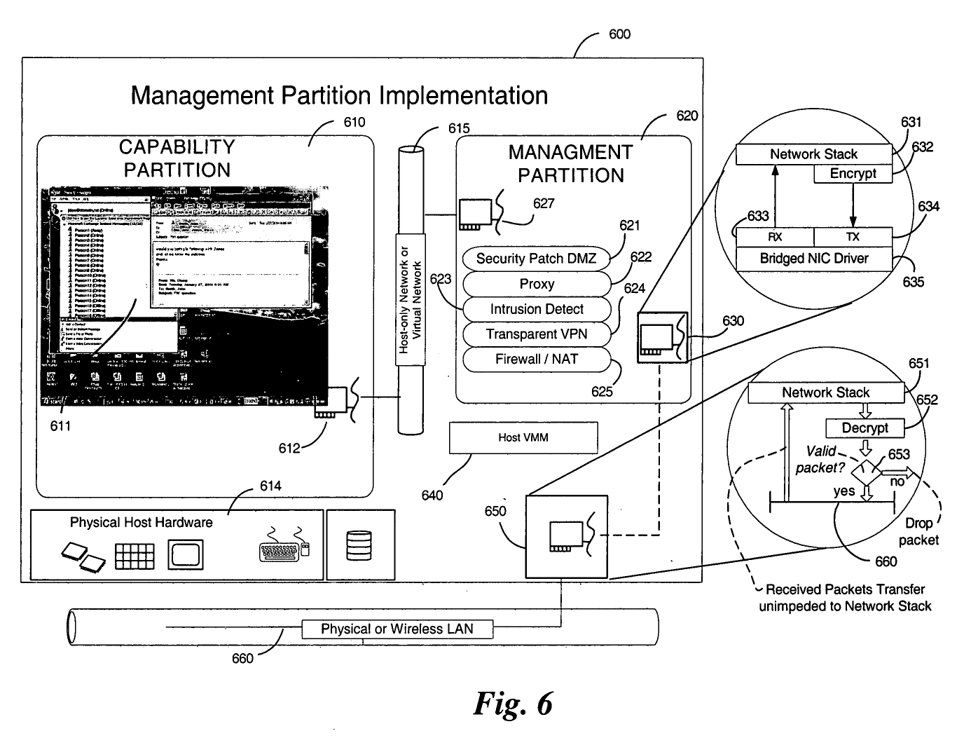

A more secure embodiment may implement a hardware modification or augmentation to the NIC 501. FIG. 6 illustrates an embodiment where a NIC requires encoding or encryption of a packet before allowing it to be sent over the network. An embodiment adds a signature or encryption or virtual private network (VPN) component to the physical NIC (501 of FIG. 5). A hardware implementation may provide better protection against tampering in an execution environment to perform decryption/validation. Further, a hardware implementation provides better protection against malicious software interference. Packets sent from an application in the system must be encoded, signed or encrypted in a method that this augmented NIC understands. The NIC decodes the packets using a hardware decryption or other mechanism to determine whether the packet is authorized. Thus, the packets are “signed” in some fashion. Unauthorized packets will not make it beyond the NIC onto the network.

Referring to FIG. 6, a virtualized platform 600 may comprise a capability partition 610 with a virtual network controller 612, physical host hardware 614, a virtual network 615 communicatively coupled to a management partition 620 and a host VMM 640. The management partition 620 may comprise secure applications for security patches 621, proxy server 622, intrusion detection 623, a transparent VPN 624, and a firewall/NAT 625. The management partition may control communication to a physical or wireless local area network (LAN) 660 via a virtual NIC 630 and physical NIC 650. In this example, an e-mail application 611, running in the capability partition 610, communicates to the network 660 via the virtual NIC 612 to virtual NIC 627. The communication packet is transmitted from the virtual NIC 612 through a virtual network 615 to a virtual NIC 627 in the management partition 620. In some embodiments, the virtual network may be a host-only network. The communication packet may be transmitted utilizing a network service on a management partition (i.e., routing/NAT/bridge 625) or by an application level proxy (i.e., web services proxy) 622 to the management partition virtual network stack 631.

The host VMM 640 virtualizes network communication and captures packets to be sent to the LAN 660, by various VMs on the platform. The packets are passed to the virtual network stack 630 in the management partition 620. This is facilitated by having the host and/or other guests use the virtual NIC 627 in the management partition as their “Default gateway.” In other words, the IP routing stack will target this virtual NIC 627 with the packets that are destined to be sent from the partition/host. Embodiments of the present invention may prevent any other path from functioning; the host (and/or) other partitions must configure in this manner to establish network connectivity with the outside world.

Packets to be sent are placed on the network stack 631 of the virtual NIC 630 and encrypted 632. In alternative embodiments, the packets are digitally signed or otherwise digitally encoded rather than encrypted. It will be apparent to one of ordinary skill in the art that various authentication or signing techniques may be used. The encoded packets may be sent 634 to a bridged NIC driver 635 and then placed on the physical network stack 651 of the physical NIC 650. A network bridge takes packets from one subnet/NIC and places them on another subnet/NIC. Bridging enables each partition/host to have a unique IP address and be externally addressable. Packets received by the virtual NIC 633 are passed through the network stack 631 to the appropriate VM. In an embodiment that uses bridging, the management partition 620 may copy the packet, after successfully being received through a firewall, if necessary. In the case of a NAT, the firewall/NAT process 625 may rewrite the IP header for a private network.

When the physical NIC 650 receives an encrypted/encoded packet in the network stack 651, the packet it decrypted or decoded 652. The decryption step may be omitted if the NIC 650 is in normal, or pass-through mode, rather than secure (decode) mode. The NIC may have multiple secure modes to accommodate various encryption schemes. If the packet is determined to be valid at 653 in a circuit, the packet is sent to the LAN 660. If the packet it determined to be invalid in 653, the packet is dropped and an error message may be sent back to the host VMM 640 or the transmitting VM 610. Packets received from the LAN 660 are sent unimpeded to the physical network stack 651. In some embodiments the decision block 653 and the decryption block 652 reside in the same circuit. In other embodiments, the decision block 653 and the decryption block 652 reside in firmware operatively coupled to the NIC 650. It will be apparent to one of ordinary skill in the art to determine how to allocate the functional components among various software, hardware and firmware solutions, and combinations thereof.

The NIC 650 may run in normal operations mode for systems without the encryption/encoding/signing capability or in a secure mode which uses the hardware modification to verify the packets authorization to be sent. By allowing multiple modes, a secure NIC which is capable of decoding the packets, may be used in legacy systems, as well as secure systems, as described herein.

In one embodiment, virtual NIC 630 and NIC 650 may be linked through an Ethernet bridge that is facilitated by the VMM 640. The encryption process 632 may encrypt all data above the Ethernet layer of the packet so that the bridge is not impeded. It will be apparent to one of ordinary skill in the art that an intelligent VMM may be designed to avoid this limitation.

In embodiments of the invention, negotiation between the NIC card and the VMM driver are used to protect the network flow. The VMM does not need to reside in a hypervisor architecture for this negotiation to work.

With virtualization there are typically two categories of VMMs: 1) Host-based VMM and 2) Hypervisor VMM. Hypervisor architecture may be implemented with some features of a host-based system and is called a hybrid VMM architecture. In a hypervisor model, multiple operating systems may be run in VMs as peers on a platform. For instance, OS A is no more privileged than OS B. A thin layer of software (VMM) may communicate with OS A and OS B. The VMM may have a scheduler in addition to the OS schedulers to allocate time slices to the guest VMs. The VMM may also virtualize some hardware. The processor timer may be mapped to the VMM. Timer interrupts must be generated for all guest VMs. This VMM controls mapping of guest VMs to services or hardware resources. Many hardware resources may be mapped directly from the hardware to the partition (VM). A partition, or VM, in a hypervisor architecture may act as a management partition, as discussed above.

In a host-based system, a VMM may run on the host OS and execute VMs in partitions as subordinate to the host OS. In some embodiments, the host-based VMM may be more privileged than other guest VMs. In some embodiments, the VMM may be a peer to the host OS. The host OS running the VMM typically has a higher privilege than OSs running in other VMs. The host OS may control all VMs, as well as physical hardware. In this host-based model, some applications are run on the host OS because it is desirable to optimize graphics, for instance, and the graphics card will be mapped to the host OS.

In some embodiments, a management partition may be a secure partition as enabled by some trusted platform technology, as may be found in Intel Corporation's secure VMM technology (see, e.g., documents describing Intel's LaGrande platform at Internet Universal Resource Locator (URL) www.intel.com/technology/security). One example of a trusted platform module (TPM) model may implement hardware embedded cryptographic engines such as those found in smartcards or a trusted platform module (TPM). The smartcard may have an embedded cryptographic engine and non-volatile storage, and the ability to perform security operations. The smartcard may be on the motherboard so it may be integrated with various parts of the platform. One aspect of system having a TPM component is the storing of the current platform state. This state may be stored using a cryptographic hash or checksum-like function. The state of the platform is determined and a hash of the state is saved to determine future integrity of the system. One feature of virtualization technology being developed in the industry is to enable a secure launch where the TPM may protect the hash of the current platform state. Thus, a VMM will launch only if the key in memory matches the hash. If a virus maliciously modifies the VMM, TPM will not allow the VMM to launch because the hash keys will not match. TPM may aid in guarding secrets by communicating with a NIC.

A hybrid VMM is an specialized class of hypervisor that leverages a dedicated guest OS to host the device drivers and create object models. In the hybrid model, not all hardware needs to be mapped to the “device OS” and may be directly mapped to one of the other partitions.

In one embodiment, the virtual network stack is implemented in software in the management partition. The process for virtualizing the network stack may be implemented in various layers of the network stack, even at the API level. In some cases, this method may be circumvented by uninstalling the software which uses the virtual stack. In another embodiment, the virtual stack is augmented by using encryption, or encoding of the packets and coupling this with a NIC that is required to decode and validate the packets before transmitting then over a network.

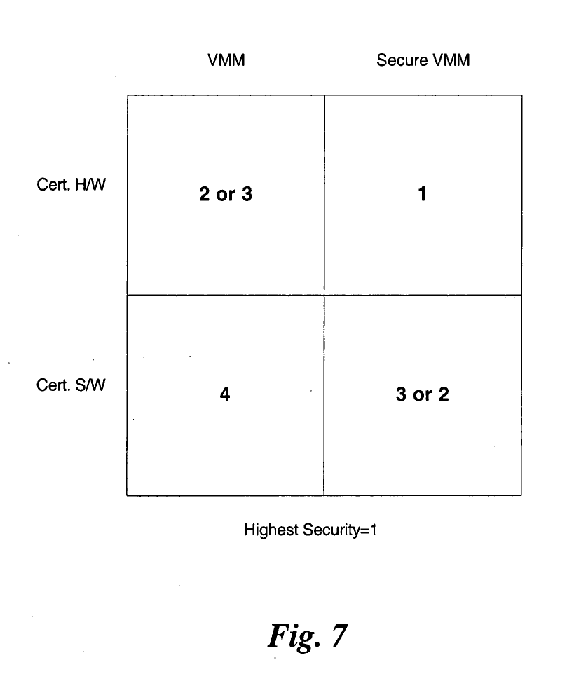

Various permutations of this method are illustrated by FIG. 7. FIG. 7 shows a table illustrating combinations of various implementations of the present invention and assigns a security level. The first column is for a platform with a standard VMM. Column 2 is for a platform with a secure VMM.

Secure VMMs typically runs in a secure partition in trusted platforms. A secure VMM can attest that it is running on top of a trusted platform by validating various stages of the platform boot and Software launch process. Additionally, these secure partitions may utilize capabilities such as those presented in a TPM platform configuration register (PCR) storage scheme. This scheme enables data to be available only upon authentication that the platform is in the appropriate and trusted state. This disables attacks such as where a rogue VMM is inserted to steal the encryption keys from the management partition.

Row 1 is for a platform using certification or decryption of a packet in hardware, i.e., a specialized NIC, and Row 2 is for a platform using certification in software, i.e., putting a specialized driver in the network stack or modifying Winsock or other API. As can be seen, a platform implemented with a secure VMM and certification in hardware is the most secure and hardest to circumvent. A platform using a standard VMM and software certification only is the least secure. It will be apparent to one of ordinary skill in the art that various implementations may be used depending on the desired application.

The techniques described herein are not limited to any particular hardware or software configuration; they may find applicability in any computing, consumer electronics, or processing environment. The techniques may be implemented in hardware, software, firmware or a combination of the three. The techniques may be implemented in programs executing on programmable machines such as mobile or stationary computers, personal digital assistants, set top boxes, cellular telephones and pagers, consumer electronics devices (including DVD players, personal video recorders, personal video players, satellite receivers, stereo receivers, cable TV receivers), and other electronic devices, that may include a processor, a storage medium accessible by the processor (including volatile and non-volatile memory and/or storage elements), at least one input device, and one or more output devices. Program code is applied to the data entered using the input device to perform the functions described and to generate output information. The output information may be applied to one or more output devices. One of ordinary skill in the art may appreciate that the invention can be practiced with various system configurations, including multiprocessor systems, minicomputers, mainframe computers, independent consumer electronics devices, and the like. The invention can also be practiced in distributed computing environments where tasks may be performed by remote processing devices that are linked through a communications network.

Each program may be implemented in a high level procedural or object oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product that may include a machine accessible medium having stored thereon instructions that may be used to program a processing system or other electronic device to perform the methods. The term “machine accessible medium” used herein shall include any medium that is capable of storing or encoding a sequence of instructions for execution by the machine and that cause the machine to perform any one of the methods described herein. The term “machine accessible medium” shall accordingly include, but not be limited to, solid-state memories, optical and magnetic disks, and a carrier wave that encodes a data signal. Furthermore, it is common in the art to speak of software, in one form or another (e.g., program, procedure, process, application, module, logic, and so on) as taking an action or causing a result. Such expressions are merely a shorthand way of stating the execution of the software by a processing system cause the processor to perform an action of produce a result.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

What is claimed is:

1. A system, comprising:
a virtualization platform capable of running a virtual machine monitor and a plurality of virtual machines, the virtual machine monitor to capture packets of information to be sent over a network by a process running in a virtual machine on the platform;
an encoder residing in a virtual machine to encode packets of information, the packets of information to be sent to a network interface card (NIC) via a network stack, wherein the encoder is communicatively coupled to a virtual network stack in the virtual machine running on the virtualization platform; and
a decoder to decode and verify the encoded packets of information, the decoder communicatively coupled to the NIC, wherein the NIC sends only verified decoded information packets and drops unverified information packets.

2. The system as recited in claim 1, wherein the encoder is a software agent coupled to the virtual network stack and the decoder is a software agent coupled to the network stack of the NIC.

3. The system as recited in claim 1, wherein the encoder is a software agent coupled to the virtual network stack and the decoder is embodied in one of a decoder circuit on the NIC and firmware operatively coupled to the NIC.

4. The system as recited in claim 3, wherein the decoder circuit decodes a received encoded packet of information and determines whether the decoded packet of information is verified before allowing the NIC to send the decoded information packet over the network.

5. The system as recited in claim 1, further comprising at least one management partition running in a virtual machine on the platform, wherein the virtual network stack resides in the at least one management partition.

6. The system as recited in claim 1, wherein the virtualization platform conforms to a virtualization architecture selected from a group of architectures consisting of host-based virtual machine monitor architecture, hypervisor architecture and hybrid hypervisor architecture.

7. The system as recited in claim 1, wherein the virtualization platform comprises a host-based virtual machine monitor architecture, wherein at least one management partition runs in a virtual machine, the at least one management partition constructed to perform at least one management service, and wherein the virtualization platform further comprises at least one capability partition, each of the at least one capability partition to be run in a virtual machine, wherein the capability partition does not have direct access to the NIC.

8. The system as recited in claim 7, wherein the at least one management service is selected from a group of services consisting of security patching, proxy services, intrusion detection, virtual private networking, firewall services, network address translation, network communication, and virtual device driver services.

9. The system as recited in claim 1, wherein the decoder is constructed to accommodate at least one encoding format, wherein the encoder encodes the information packet using the at least one encoding format selected from a group of formats consisting of encryption, digital signature and digital encoding.

10. The system as recited in claim 1, wherein the NIC is constructed to selectively accommodate one of a decoding mode and a pass-through mode.

11. A method for sending packets in a virtualization platform, comprising:
sending a packet of information by an application running on the platform, the packet of information to be sent over a network, wherein the packet is sent to a first virtual network interface;
capturing the packet of information by a management partition running in a first virtual machine on the platform;
encoding a packet of information by an encoder residing in the management partition, the encoder communicatively coupled to a virtual network stack; and
sending the encoded packet of information to a physical network interface, the physical network interface being capable of decoding and authenticating the encoded packet, the physical network interface being capable of sending authenticated packets and dropping unauthenticated packets.

12. The method as recited in claim 11, wherein the application runs in one of a second virtual machine and a host operating system partition.

13. The method as recited in claim 11, wherein the virtualization platform comprises a virtualization architecture selected from a group of architectures consisting of host-based virtual machine monitor architecture, hypervisor architecture and hybrid hypervisor architecture.

14. The method as recited in claim 11, wherein the management partition comprises a virtual machine monitor.

15. The method as recited in claim 11, wherein the virtualization platform comprises a host-based virtual machine monitor architecture, wherein the management partition running in the first virtual machine is constructed to perform at least one management service, and wherein the virtualization platform further comprises at least one additional virtual machine, each of the at least one additional virtual machine, wherein an additional application runs in the additional virtual machine, wherein the applications running in respective virtual machines do not have direct access to the physical network interface.

16. The method as recited in claim 15, wherein the at least one management service is selected from a group of services consisting of security patching, proxy services, intrusion detection, virtual private networking, firewall services, network address translation, network communication, and virtual device driver services.

17. The method as recited in claim 11, wherein the decoding performed by the physical network interface accommodates at least one encoding format, wherein the encoding comprises encoding the information packet using the at least one encoding format selected from a group of formats consisting of encryption, digital signature and digital encoding.

18. The method as recited in claim 11, wherein the decoding and authenticating of the encoded packet is performed by a software agent communicatively coupled to a network stack corresponding to the physical network interface.

19. The method as recited in claim 11, wherein the decoding and authenticating of the encoded packet is performed by a circuit communicatively coupled to the physical network interface.

20. The method as recited in claim 11, wherein the decoding and authenticating of the encoded packet is performed by firmware communicatively coupled to the physical network interface.

21. The method as recited in claim 11, wherein encoding the information packet performs at least one encoding task selected from a group of encoding tasks consisting of encrypting, digitally signing and digitally encoding, wherein the physical network interface is constructed to decode the encoded information packet.

22. The method as recited in claim 11, wherein the physical network interface is constructed to selectively accommodate one of a decoding mode and a pass-through mode.

23. A machine accessible medium having instructions for sending packets in a virtualization platform, the instructions when accessed cause the machine to:
send a packet of information by an application running on the platform, the packet of information to be sent over a network, wherein the packet is sent to a first virtual network interface;
capture the packet of information by a management partition running in a first virtual machine on the platform;
encode a packet of information by an encoder residing in the management partition, the encoder communicatively coupled to a virtual network stack; and
send the encoded packet of information to a physical network interface, the physical network interface being capable of decoding and authenticating the encoded packet, the physical network interface being capable of sending authenticated packets and dropping unauthenticated packets.

24. The machine accessible medium as recited in claim 23, wherein the application runs in one of a second virtual machine and a host operating system partition.

25. The machine accessible medium as recited in claim 23, wherein the virtualization platform comprises a virtualization architecture selected from a group of architectures consisting of host-based virtual machine monitor architecture, hypervisor architecture and hybrid hypervisor architecture.

26. The machine accessible medium as recited in claim 23, wherein the management partition comprises a virtual machine monitor.

27. The machine accessible medium as recited in claim 11, wherein the virtualization platform comprises a host-based virtual machine monitor architecture, wherein the management partition running in the first virtual machine is constructed to perform at least one management service, and wherein the virtualization platform further comprises at least one additional virtual machine, each of the at least one additional virtual machine, wherein an additional application runs in the additional virtual machine, wherein the applications running in respective virtual machines do not have direct access to the physical network interface.

28. The machine accessible medium as recited in claim 27, wherein the at least one management service is selected from a group of services consisting of security patching, proxy services, intrusion detection, virtual private networking, firewall services, network address translation, network communication, and virtual device driver services.

29. The machine accessible medium as recited in claim 23, wherein the decoding performed by the physical network interface accommodates at least one encoding format, wherein the encoding comprises encoding the information packet using the at least one encoding format selected from a group of formats consisting of encryption, digital signature and digital encoding.

30. The machine accessible medium as recited in claim 23, wherein the decoding and authenticating of the encoded packet is performed by a software agent communicatively coupled to a network stack corresponding to the physical network interface.

31. The machine accessible medium as recited in claim 23, wherein the decoding and authenticating of the encoded packet is performed by a circuit communicatively coupled to the physical network interface.

32. The machine accessible medium as recited in claim 23, wherein the decoding and authenticating of the encoded packet is performed by firmware communicatively coupled to the physical network interface.

33. The machine accessible medium as recited in claim 23, wherein encoding the information packet performs at least one encoding task selected from a group of encoding tasks consisting of encrypting, digitally signing and digitally encoding, wherein the physical network interface is constructed to decode the encoded information packet.

34. The machine accessible medium as recited in claim 23, wherein the physical network interface is constructed to selectively accommodate one of a decoding mode and a pass-through mode.
